(19) United States
(12) Patent Application Publication
(10) Pub. No.: US 2014/0173846 A1
(43) Pub. Date: Jun. 26, 2014

(54) DRIVE MEMBER, DEVICE FOR HOLDING A PIPE, IN PARTICULAR FOR WINDSCREEN WASHER LIQUID, AND CORRESPONDING WIPER SYSTEM

(71) Applicant: Valeo Systèmes d'Essuyage, Le Mesnil Saint Denis (FR)

(72) Inventor: David Peschard, Coudes (FR)

(73) Assignee: Valeo Systèmes d'Essuyage, Le Mesnil Saint Denis (FR)

(21) Appl. No.: 14/101,819

(22) Filed: Dec. 10, 2013

(30) Foreign Application Priority Data
Dec. 10, 2012 (FR) 1261821

(51) Int. Cl. B60S 1/34

(52) U.S. Cl. CPC B60S 1/3425
USPC 15/250.34

(57) ABSTRACT

A drive member for a wiper carrier of a wiper system for a motor vehicle is disclosed. The driver member includes an orifice designed to receive a drive shaft, the drive shaft being able to rotate about a rotation axis, and an external contour when this drive member is viewed along the rotation axis. The drive member also includes a housing having a groove formed on the drive member and designed to partially receive the pipe in the configuration in which, when the drive member is viewed along the rotation axis and when the pipe is installed on the drive member, the pipe has a curved portion set back from the external contour of the drive member, and a holding means for holding the pipe in the groove when the pipe is installed on the drive member.

The invention relates to a drive member for a wiper carrier of a wiper system for a motor vehicle. The invention also relates to a holding device for holding a pipe, in particular for windscreen washer liquid, on a motor vehicle wiper system. The invention also relates to a corresponding wiper system.

Motor vehicle wiper systems incorporate wipers for removing all forms of water or solid residues, for example insects, that can hamper the driver's view. In order to improve the removal of solid residues, and effectively clean the windscreen, it is possible to spray a solution, often a hydroalcoholic solution of the motor vehicle windscreen washer liquid type, onto the windscreen.

The windscreen washer liquid is sprayed onto the windscreen by way of spraying devices. These spraying devices may be provided either on the bonnet by way of nozzles integrated into this bonnet, or be incorporated directly into the structure of the wiper, in order to improve the washing of the windscreen, by way of a multitude of micro-perforations along the blade. In the latter case, it is necessary to supply the windscreen washer liquid directly to the wiper by way of a pipe which must be held correctly during the alternating movements of the wiper on the windscreen.

Patent application JP2006-306286 describes a windscreen wiper comprising an arm head connected to a drive shaft, this head being covered by a cover. A windscreen washer liquid pipe, which extends both along the arm and along the arm head, is connected to a washer nozzle fixed to the wiper in order to spray a windscreen washer liquid onto the windscreen. The pipe is firstly positioned on the arm head against an annular wall of this arm head and is then held in position by the cover once the latter has been fitted onto the arm head.

This implementation has a drawback. Specifically, in order to hold the windscreen washer liquid pipe on the arm head, it is necessary to trap a portion of the pipe which is then in contact with two components, namely the arm head and the cover. Having two components to hold the windscreen washer liquid pipe can generate complex mounting operations, and in particular can require a precise clearance between the two components.

In addition, when the pipe is being mounted on the arm head, it is necessary to temporarily hold the pipe in position on the head while the cover is lowered. This handling step is delicate since it requires the operator to pay attention in order to ensure that the windscreen washer liquid pipe is held properly on the arm head.

One aim of the invention is in particular to propose a device for holding a pipe, in particular for windscreen washer liquid, on a wiper system in a relatively simple manner.

This aim is achieved, in accordance with the present invention, by way of a drive member for a wiper carrier of a wiper system for a motor vehicle, said drive member:
having an orifice designed to receive a drive shaft, the drive shaft being able to rotate about a rotation axis, and
having an external contour when this drive member is viewed along the rotation axis,
   characterized in that the drive member has:
a housing comprising a groove formed on the drive member and designed to at least partially receive the pipe in the configuration in which, when the drive member is viewed along the rotation axis and when the pipe is installed on the drive member, the pipe has a curved portion set back from the external contour of the drive member, and
a holding means that is able to hold the pipe in the groove when the pipe is installed on the drive member.

The invention makes it possible to hold the curved portion of the pipe by way of a single component, namely the drive member. This makes it possible to avoid the use of an additional component to hold the curved portion.

In other words, the curved portion of the pipe is held in a self-sufficient manner by the drive member.

In addition, since the curved portion of the pipe is set back from the external contour of the drive member, this curved portion is at least partially concealed, thereby improving the appearance of the wiper system.

If desired, the drive member has a substantially elongate shape along a longitudinal axis and the orifice is positioned in the vicinity of one longitudinal end of the drive member.

This orifice is for example approximately circular when it is viewed along the rotation axis.

Advantageously, the groove has a shape corresponding to the shape of the pipe intended to be installed on the drive member. According to one exemplary embodiment, the groove is approximately cylindrical. The groove has a radius of around 2 to 3 mm, for example around 2.75 mm.

Preferably, the external contour of the drive member is approximately in the form of a circular arc around the orifice.

The drive member advantageously has at least one holding tab designed to hold the curved portion of the pipe in the groove when the pipe is installed on the drive member.

Advantageously, the holding tab is produced in one piece with the drive member.

Preferably, the drive member has a lower face intended to be positioned facing the bonnet of the vehicle, and the housing is positioned on the lower face of the drive member.

In one exemplary embodiment, the lower face is substantially planar.

According to one embodiment, said at least one holding tab is connected to the lower face of the drive member and has a bent-back portion extending approximately parallel to the lower face and intended to bear against the curved portion of the pipe when the pipe is installed on the drive member.

According to one aspect of the invention, the drive member comprises a rib formed on the lower face of the drive member and the holding means is connected to the rib.

Advantageously, the rib is approximately in the form of a circular arc, in particular centred on the orifice of the drive member when the drive member is viewed along the rotation axis.

Said at least one holding tab may be produced together with the rib.

According to one embodiment, the drive member preferably has at least one element for guiding the windscreen washer liquid pipe, in particular designed to guide the pipe towards a return spring.

According to one aspect, the drive member has a substantially elongate shape and the guiding element is positioned in the vicinity of one longitudinal end of the drive member, in particular at the opposite longitudinal end from the orifice.

The guiding element may be produced in the form of a hook that defines a semi-open approximately cylindrical housing, for shape cooperation with a pipe having an approximately cylindrical shape.

The invention also relates to a holding device for holding a washer liquid pipe, said device having: the pipe, a drive member having an orifice designed to receive a rotating shaft, this shaft being able to rotate about a rotation axis, the drive member having an external contour when this drive member is viewed along the rotation axis,
characterized in that the drive member has:
a housing comprising a groove formed on the drive member and designed to at least partially receive the pipe in the configuration in which the pipe has a curved portion around the orifice and, when the drive member is viewed along the rotation axis, the curved portion of the pipe is set back from the external contour of the drive member, and
a means for holding the pipe in the groove.

In a particularly advantageous manner, the holding device is designed to allow the pipe to be mounted in a removable manner in the housing. Thus, the pipe is able to be positioned in a removable manner in the housing and may easily be replaced.

The windscreen washer liquid pipe is positioned so as to be able to be connected at a first end to a windscreen washer liquid reservoir and at a second end to a windscreen washer liquid spraying device, in particular connected to a windscreen wiper.

The pipe is flexible, and is advantageously produced from ethylene propylene diene monomer, known as EPDM.

A further subject of the invention is a wiper system for a motor vehicle, which is able to drive a drive shaft, characterized in that it has a holding device as defined above, and the drive member of the holding device is able to cooperate with the drive shaft.

According to one aspect of the invention, the wiper system has a drive motor and/or a rod linkage designed to cooperate with the drive shaft that is able to cooperate with the drive member of the holding device.

The drive shaft is thus connected on one side to the drive member and on the other side to the drive motor and/or to the rod linkage.

If desired, the orifice of the drive member is able to cooperate with the upper end of the drive shaft and the cap is able to cover the upper end of the drive shaft. This cap is preferably fixed in a removable manner to the drive shaft.

The wiper system may have: an arm and a wiper carrier casing designed to cooperate with the drive member, a wiper designed to cooperate with the arm, a windscreen washer liquid spraying device, connected to the arm.

The wiper system also preferably has a reservoir and a pump for windscreen washer liquid, connected to one end of the pipe of the holding device, the pump making it possible to convey the windscreen washer liquid from the reservoir to the spraying device. The pump is designed to be triggered by the user from the interior of the vehicle.

Further features and advantages of the invention will become more clearly apparent from reading the following description, given by way of nonlimiting illustrative example, and the appended drawings, in which:

FIG. 1 is a first schematic and partial perspective view of a wiper system,

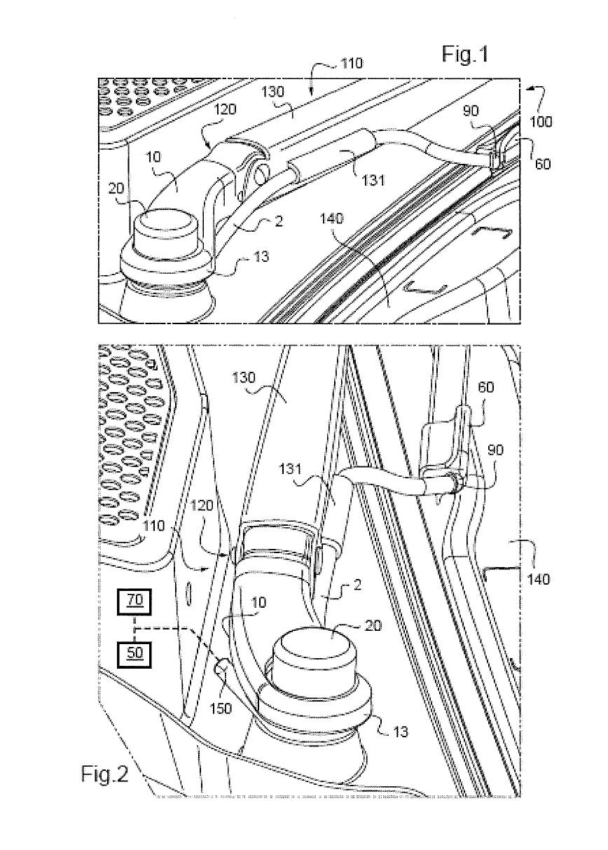

FIG. 2 is a second schematic and partial perspective view of the wiper system,

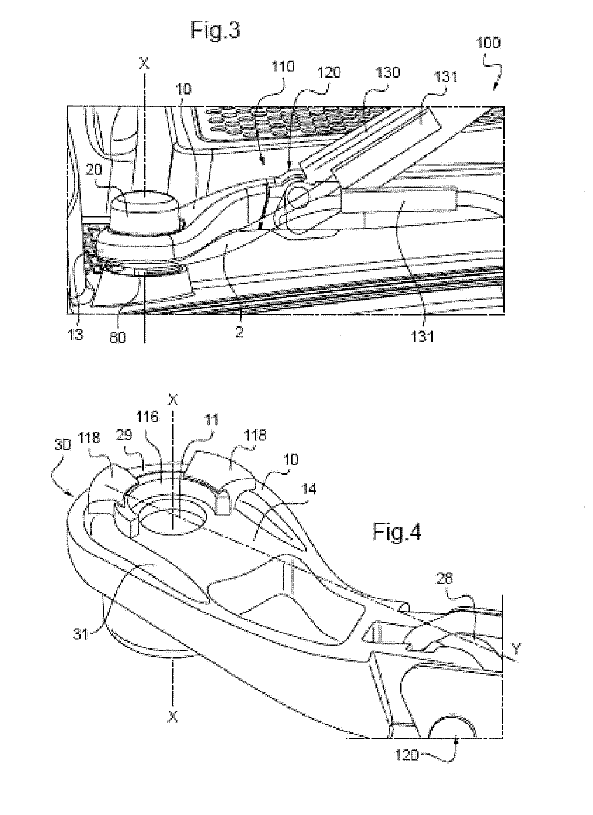

FIG. 3 is a schematic and partial side view of the wiper system,

FIG. 4 is a schematic and partial view of a drive member according to a first embodiment of the wiper system without the pipe,

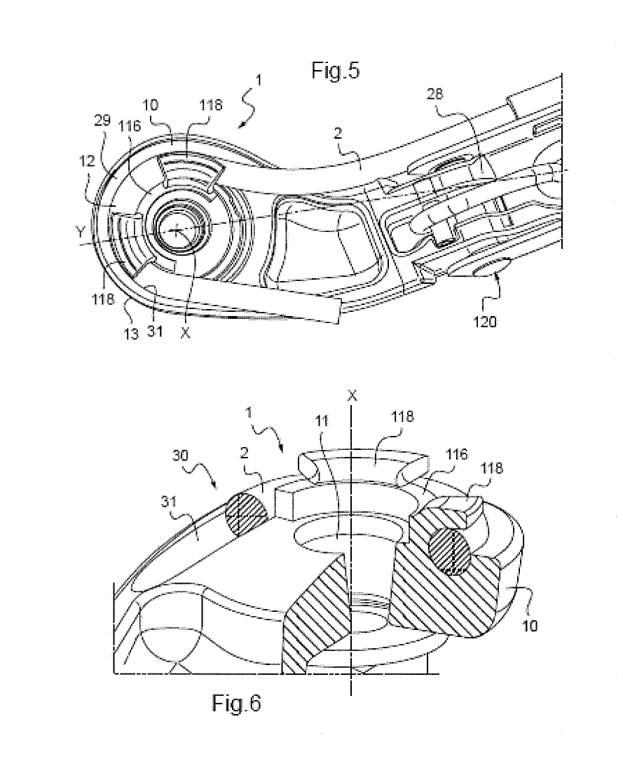

FIG. 5 is a schematic and partial view of the drive member according to the first embodiment of the wiper system with the pipe,

FIG. 6 is a partial view of the drive member and of the pipe of the wiper system from FIG. 5, and

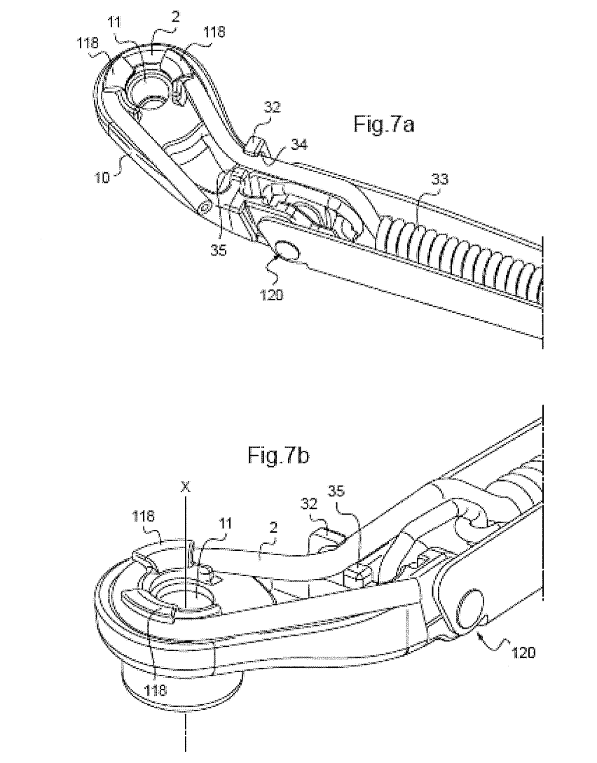

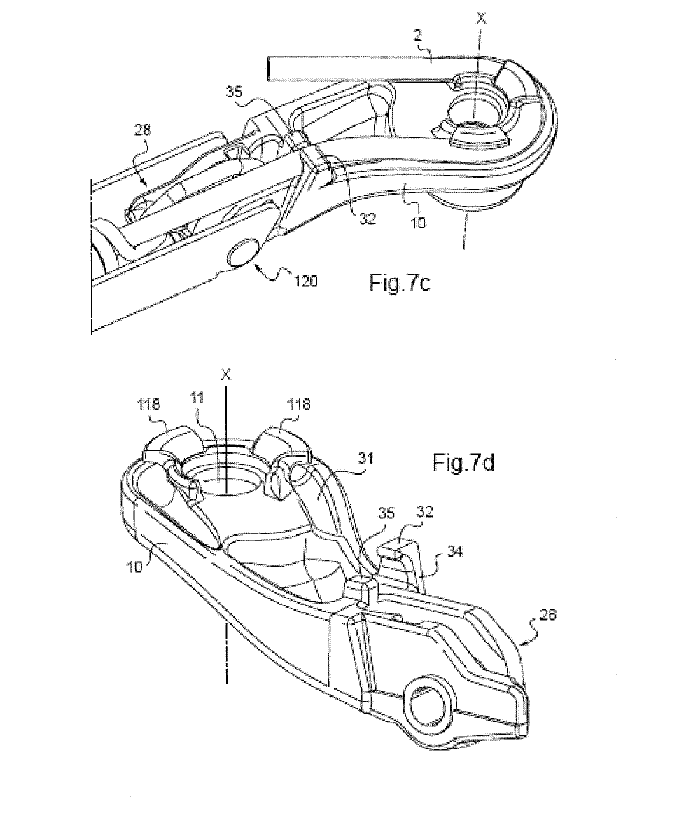

FIG. 7a is a first perspective view of a drive member according to a second embodiment of the wiper system with the pipe,

FIG. 7b is a second perspective view, substantially from the side, of the drive member according to the second embodiment with the pipe,

FIG. 7c is a third perspective view, substantially from the side, of the drive member according to the second embodiment with the pipe, and

FIG. 7d is a perspective view of the drive member according to the second embodiment without the pipe.

In these figures, substantially identical elements bear the same references.

FIGS. 1 to 3 show, in a partial and schematic manner, a wiper system 100 for a motor vehicle, more specifically for cleaning a windscreen 140 of the vehicle.

The wiper system 100 comprises:
a wiper carrier 110 installed on the vehicle and carrying a wiper 60,
at least one device 90 for spraying a liquid for washing the windscreen 140, known as windscreen washer liquid,
a pipe 2 for conveying the windscreen washer liquid to the spraying device 90, and
a device 1 for holding the pipe 2 so as to correctly hold it during the alternating movements of the wiper 60 on the windscreen 140.

The wiper carrier 110 comprises a drive member 10 described in more detail below. The wiper carrier 110 comprises, in addition to the drive member 10, an arm continuing a wiper carrier casing 130 secured to the drive member 10. The wiper carrier casing 130 is produced for example from galvanized or electro-galvanized sheet metal.

The drive member 10 and the wiper carrier casing 113 may be secured together for example by means of a pivot assembly 120. The pivot assembly 120 allows the user to pivot the wiper carrier casing 130 with respect to the drive member 10 and thus to manipulate a wiper 60 placed at one end of the arm.

The drive member 10 is able to be actuated in rotation over a predefined angular range by way of a drive shaft 80 having a rotation axis X. The drive member 10 is thus able to cooperate with the drive shaft 80.

This rotation ensures that the arm and the wiper 60 sweep over the windscreen 140. The wiper carrier casing 130 is articulated in a pivoting manner about the pivot assembly 120, in this case approximately perpendicular to the rotation axis X of the drive shaft 80.

The wiper 60 removes the water or solid residues present on the windscreen 140 of the vehicle. Such a wiper 60 is for example of the flat blade type, that is to say comprising a scraper, one or more stiffening vertebrae and a central single fastening produced by a mechanical connector attached to one end of the arm. Such a flat wiper 60 may also have an air deflector integral with the wiper and designed to exploit the dynamic effect of the movement of the vehicle to increase the bearing force of the wiper 60 on the windscreen 140.

The wiper carrier 110 or the wiper 60 are connected to a device 90 for spraying liquid for washing the windscreen 140, known as windscreen washer liquid. According to the exemplary embodiment shown in FIG. 1, the spraying device 90 may have a duct incorporated into the wiper 60, said duct running along the longitudinal axis of this wiper 60. Such a duct may for example be formed in a part of the structure of the air deflector. According to an exemplary embodiment which is not shown, the spraying device 90 may have a spray bar separate from the wiper 60 and connected to the arm.

The spraying device 90 comprises pressurized spray nozzles or orifices, allowing the distribution of the windscreen washer liquid over the glazed surface, these being, according to this exemplary embodiment, incorporated into the structure of the wiper 60.

The device 90 for spraying the windscreen washer liquid is supplied with windscreen washer liquid by the pipe 2.

The pipe 2 may be produced from a flexible material such as EPDM (ethylene propylene diene monomer).

In the example described, the pipe 2 extends from an outlet under the bonnet 150 to the wiper 60.

This pipe 2 may, for example, be secured to the wiper carrier casing 130 with the aid of securing means 131 which hold the pipe 2 in position on the wiper carrier casing 130. According to the example illustrated in FIG. 1, the securing means are substantially in the form of bridging pieces. The bridging pieces 131 are produced for example from plastics material, such as polyamide 6,6. The bridging pieces 131 may be clip-fastened to the wiper carrier casing 130.

The windscreen washer liquid is contained in a reservoir 50. At one end, the pipe 2 is connected under the bonnet (not shown in the figures) to the windscreen washer liquid reservoir 50 associated with a pump 70 for conveying the windscreen washer liquid from the reservoir 50 to the spraying device 90. This connection between the pipe 2 and the reservoir 50 associated with a pump 70 is shown in a schematic and illustrative manner by the dashed lines in FIG. 2. The pump 70 is designed to be able to be triggered from the interior of the vehicle by the driver or by an automated system.

The windscreen washer liquid pipe 2 is connected at a second end to the device 90 for spraying windscreen washer liquid.

The pipe 2 is also held on the drive member 10 with the aid of the holding device 1. The pipe 2 thus installed and held on the drive member 10 has a substantially curved portion 12.

The holding device 1 comprises:
the pipe 2, and
the drive member 10 of the wiper carrier 110.

The drive member 10 is produced for example in one piece by moulding a material of the aluminium or zamak type.

The drive member 10 extends generally longitudinally along an axis Y. According to the embodiment described, the drive member 10 extends in a direction parallel, or approximately parallel, to a direction of extension of the wiper carrier casing 130 of the wiper carrier 110 between two opposite longitudinal ends 28 and 29, shown in FIGS. 4 and 5.

The first end 28 of the drive member 10 is configured to allow the drive member 10 to be fastened to the wiper carrier casing 130, for example by the pivot assembly 120.

The second end 29 is designed to secure the drive member 10 to the drive shaft 80, of rotation axis X. To this end, the drive member 10 comprises, in the region of the second end 29, an orifice 11 designed to receive the drive shaft 80. This orifice 11 has an approximately circular shape when it is viewed along the axis X.

The drive member 10 transmits the rotary movement of the drive shaft 80 towards the arm.

The drive member 10 is secured to the drive shaft 80 by a nut (not shown in FIG. 1) which is screwed onto the drive shaft 80. The nut (not shown in the figures) is covered by a cap 20 or nut cover which is placed on top of the drive member 10, that is to say on a face of the drive member, known as the upper face, on the opposite side from the bonnet of the vehicle. This upper face is for example substantially planar.

The cap 20 advantageously has an approximately circular contour.

The cap 20 is obtained for example by injection-moulding plastics material, such as polyethylene.

In the region of the second end 29, the drive member 10 has an external contour 13 in the form of a circular arc when the drive member 10 is viewed along the axis X.

The drive member 10 has a lower face 14 facing the bonnet of the vehicle, as opposed to an external face that is visible from the outside of the vehicle. The lower face 14 is substantially planar in the example illustrated in FIGS. 4 and 5. Around the orifice 11 and on its lower face 14, the drive member 10 has a housing 30, shown in FIG. 4, designed to receive the curved portion 12 of the windscreen washer liquid pipe 2.

As illustrated in FIGS. 1 to 3, the curved portion 12 of the pipe 2 is set back from the external contour 13 of the drive member 10 when the holding device 1 is viewed along the rotation axis X.

Thus, when the drive member 10 is folded down against the windscreen 140, as illustrated in FIG. 1, the curved portion 12 is invisible when the device 1 is viewed along the rotation axis X.

This makes it possible to enhance the appearance of the device 1.

The housing 30 of the drive member 10 is described in more detail with reference to FIGS. 4 and 5.

According to the embodiment illustrated in FIG. 4, the housing 30 of the drive member 10 has a groove 31 formed on the lower face 14 of the drive member 10.

The groove 31 is shaped for shape cooperation with the pipe 2. Thus, the groove 31 has a shape and a depth corresponding to the shape and dimensions of the pipe 2.

According to the example illustrated, the pipe 2 is approximately cylindrical and the groove 31 is approximately cylindrical and has for example a radius of around 2 to 3 mm, for example 2.75 mm This radius is given by way of nonlimiting example for a standard pipe 2 having a diameter of around 5.5 mm +/−0.3 mm.

Of course, other shapes and other dimensions may be envisaged depending on needs.

The driver 10 also has at least one means for holding the curved portion 12 of the pipe in the groove 31. This may in particular be at least one holding tab 118. According to the example illustrated in FIG. 4, the drive member 10 has two holding tabs 118 designed to hold the curved portion 12 of the pipe 2 in the housing 30.

Of course, more than two holding tabs 118 may be provided.

The holding tabs 118 may be connected to the lower face 14 of the drive member 10. The holding tabs 118 may be produced in one piece with the drive member 10.

The holding tabs 118 each have a bent-back portion that bears against the curved portion 12 of the pipe 2.

According to the example illustrated, the bent-back portion of one holding tab 118 extends approximately parallel to the lower face 14 of the drive member 10.

These holding tabs 118 hold the curved portion 12 of the pipe effectively during the oscillating movements of the wiper carrier casing 130 of the windscreen wiper.

By way of the groove 31 and the holding means such as the holding tabs 118, the pipe 2 is fitted on the drive member 10 in a removable manner, making it possible, if need be, to change the pipe 2 relatively easily.

According to a variant illustrated in FIG. 4, the drive member 10 may have a rib 116. The rib 116 is for example in the form of a circular arc. This circular arc may be centred on the orifice 11 when the drive member 10 is viewed along the rotation axis X. Furthermore, the rib 116 may be positioned in the vicinity of the orifice 11.

The holding tabs 118 may be connected to the top of the rib 116 (see FIGS. 4 to 6). The holding tabs 118 may be produced in one piece with the rib 116.

The length of the circular arc of the rib 116 may be modified depending on the number of holding tabs 118 connected to the rib 116. According to a variant which is not illustrated, the rib 116 may be in the form of a circle.

Of course, one or more ribs 116 may be provided.

According to a second embodiment illustrated in FIGS. 7a to 7d, the drive member 10 also has an element 32 for guiding the windscreen washer liquid pipe 2, said guiding element 32 being designed to guide the pipe 2 in particular towards a return spring 33. This spring 33 serves to apply a pressure on the windscreen wiper in order for the latter to be pressed correctly against the glass of the windscreen 140.

The guiding element 32 is shaped so as to allow the pipe 2 to pass through and be held, the guiding element 32 thus having a shape and dimensions complementary to those of the pipe 2.

In this case, the pipe 2 is approximately cylindrical and the guiding element 32 is for example produced in the form of a curved hook 32 having a semi-open approximately cylindrical housing 34 for guiding and holding the pipe 2. In a similar manner to the groove 31, the radius of the semi-open housing 34 may be around 2 to 3 mm, for example 2.75 mm.

The guiding element 32 is positioned, according to the example illustrated in FIG. 7, approximately on the side in the vicinity of the first end 28. This positioning allows in particular improved guidance of the pipe 2 towards the return spring 33.

Furthermore, the drive member 10 may have a stop 35 for preventing the lateral movement of the pipe 2 and thus for improving the guidance of the pipe 2 towards the spring 33. This stop 35 is positioned opposite the semi-open housing 34 defined by the hook 32.

The guiding element 32 and the stop 35 are connected to the lower face 14 of the drive member 10 in this example.

Thus, in order to mount the pipe 2 in the drive member 10, the pipe 2 may be introduced substantially radially into the groove 31 of the drive member 10. The term “radially” is used with reference to the rotation axis X. The pipe 2 is thus deformed such that the curved portion 12 is inserted into the groove 31 formed on the drive member 10.

The pipe 2 is thus held in this groove 31 with the aid of the holding tab or tabs 118 disposed around the orifice 11 of the drive member 10.

Next, the pipe 2 is directed towards the side of the wiper carrier casing 130 to which it is fixed for example with the aid of the bridging pieces 131, or, according to the variant illustrated in FIG. 7, towards the return spring 33 for example with the aid of the guiding element produced in the form of a hook 32.

Thus, the curved portion of the pipe 2 is held by way of a single component, specifically the drive member 10, without requiring an additional component for holding the curved portion of the pipe 2.

In addition, since the curved portion 12 of the pipe 2 is set back from the external contour 13 of the drive member 10, this curved portion 12 is at least partially concealed, thereby improving the appearance of the wiper system.

1. A drive member for a wiper carrier of a wiper system for a motor vehicle, said drive member comprising:
an orifice designed to receive a drive shaft, the drive shaft being able to rotate about a rotation axis; and
an external contour when the drive member is viewed along the rotation axis;
a housing comprising a groove formed on the drive member and designed to at least partially receive the pipe in the configuration in which, when the drive member is viewed along the rotation axis and when the pipe is installed on the drive member, the pipe has a curved portion set back from the external contour of the drive member; and
a holding means that is able to hold the pipe in the groove when the pipe is installed on the drive member.

2. The drive member according to claim 1, wherein the groove is approximately cylindrical.

3. The drive member according to claim 2, wherein the groove has a radius of around 2 to 3 mm.

4. The drive member according to claim 1 the external contour of the drive member is approximately a circular arc around the orifice.

5. The drive member according to claim 1, wherein the holding means has at least one holding tab designed to hold the curved portion of the pipe in the groove when the pipe is installed on the drive member.

6. The drive member according to claim 1, further comprising a lower face intended to be positioned facing the bonnet of the vehicle, and wherein the housing is formed on the lower face.

7. The drive member according to claim 6, wherein the holding means is positioned on the lower face of the drive member.

8. The drive member according to claim 7, wherein said at least one holding tab is connected to the lower face of the drive member and has a bent-back portion extending approximately parallel to the lower face and intended to bear against the curved portion of the pipe when the pipe is installed on the drive member.

9. The drive member according to claim 6, comprising a rib formed on the lower face of the drive member and wherein the holding means is connected to the rib.

10. The drive member according to claim 1, wherein the rib is approximately in the form of a circular arc, centred on the orifice of the drive member when the drive member is viewed along the rotation axis.

11. The drive member according to claim 1, comprising an element for guiding the pipe.

12. The drive member according to claim 11, having a substantially elongate shape, the guiding element being positioned in the vicinity of one longitudinal end of the drive member.

13. The drive member according to claim 12, wherein the guiding element is produced in the form of a hook that defines a semi-open approximately cylindrical housing.

14. A holding device for holding a washer liquid pipe, said device comprising:
the pipe;
a drive member having an orifice designed to receive a rotating shaft, this shaft being able to rotate about a rotation axis, the drive member having an external contour when this drive member is viewed along the rotation axis;
wherein the drive member comprises:
a housing comprising a groove formed on the drive member and designed to at least partially receive the pipe in the configuration in which the pipe has a curved portion around the orifice and, when the drive member is viewed along the rotation axis, the curved portion of the pipe is set back from the external contour of the drive member, and
a means for holding the pipe in the groove.

15. The holding device according to claim 14, wherein the pipe is able to be positioned in a removable manner in the housing.

16. A wiper system for a motor vehicle, which is able to drive a drive shaft, characterized in that it has a holding device according to claim 14, and the drive member of the holding device is able to cooperate with the drive shaft.
